(19) United States
(12) Patent Application Publication
(10) Pub. No.: US 2014/0232123 A1
(43) Pub. Date: Aug. 21, 2014

(54) HOSE SUPPORT APPARATUS

(71) Applicant: EDISON NATION, LLC, Charlotte, NC (US)

(72) Inventors: Peter LAVELLE, Wilbraham, MA (US); Thomas James PHILPOTT, Charlotte, NC (US); Scott DROMMS, Waxhaw, NC (US); Jeff BROWNING, Charlotte, NC (US)

(73) Assignee: EDISON NATION, LLC, Charlotte, NC (US)

(21) Appl. No.: 13/828,219

(22) Filed: Mar. 14, 2013

Related U.S. Application Data
(60) Provisional application No. 61/767,205, filed on Feb. 20, 2013.

(51) Int. Cl. B65G 7/12

(52) U.S. Cl. CPC B65G 7/12
USPC 294/137

(57) ABSTRACT

A hose support apparatus includes a spine member defining an axis, a handle attached along the spine member and first and second arcuate supports extending downwardly and inwardly from opposite sides of the spine member. The first arcuate support extends from the spine member at a first end thereof and the second arcuate support extends from the spine member at a second end thereof such that the arcuate supports are adapted to support a section of a hose co-axially aligned with the spine member.

### CROSS REFERENCE TO RELATED APPLICATIONS

The present application is a U.S. non-provisional patent application of, and claims priority under 35 U.S.C. §119(e) to, U.S. provisional patent application Ser. No. 61/767,205, filed Feb. 20, 2013, which is expressly incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND

1. Field

The present invention relates generally to a garden tool, and, in particular, to a garden tool for supporting at least a portion of a garden hose in order to keep a user's hands and clothes clean during handling of the garden hose.

2. Background

Using a garden hose can be a dirty process. A garden hose is generally dragged along the ground to a designated watering or storage location. As the hose is dragged along the ground, the surface of the hose can become dirty with mud, dirt, grass or other yard debris. Furthermore, the dirt on the outside of a hose is compounded and becomes muddy with water dripping down the exterior of the hose. As a result, a user's hands often become dirty when handling (i.e. controlling, moving, extending, or retracting) a hose. Additionally, a hose that is coiled for storage has the tendency to “flip over” and inadvertently come into contact with a user's clothing, thereby increasing the chance that the user is exposed to dirt, mud or debris from the hose.

Accordingly a need exists for a garden tool capable of controlling, moving, extending, or retracting a hose in an easy manner and in such a way as to eliminate the mess associated with direct handling. This and other needs are addressed by one or more aspects of the present invention.

### SUMMARY

The present invention includes a hose support apparatus. Broadly defined, the present invention according to a first aspect includes a hose support apparatus that includes a spine member, a handle attached along the spine member and first and second arcuate supports extending downwardly and inwardly from opposite sides of the spine member. The first arcuate support extends from the spine member at a first end thereof and the second arcuate support extends from the spine member at a second end thereof such that the arcuate supports are adapted to support at least a portion of a hose engaged therewith.

In features of this aspect, each arcuate support may be tapered toward an exposed edge; each arcuate support may include an aperture therein; each arcuate support may include a rim to reduce splatter; the hose support apparatus may be composed of a rigid material; the hose support apparatus may be composed of a plastic material; outer longitudinal edges of each arcuate support may include a ramp to facilitate hose engagement; the handle may be integral with the spine member; the handle may include at least one hook to facilitate storage; and/or the at least one hook may be a pair of hooks.

Broadly defined, the present invention according to a second aspect includes a hose support apparatus substantially as shown and described.

Broadly defined, the present invention according to a third aspect includes a hose support apparatus for keeping a user's hands and clothes clean when handling a hose, substantially as shown and described.

Broadly defined, the present invention according to a fourth aspect includes a method of keeping a user's hands and clothes clean when using a hose. The method includes providing a garden tool having a handle attached along a spine member with first and second arcuate supports extending downwardly and inwardly from the spine member at opposite sides thereof, the first arcuate support extending from the spine member at a first end of the spine member and the second arcuate support extending from the spine member at a second end thereof. The method further includes positioning a portion of a hose at a gap between the first and second arcuate supports and arranging the garden tool such that the first and second arcuate supports engage with and support the portion of the hose.

In features of this aspect, the method may further include re-positioning the garden tool relative to the hose by moving the garden tool along the hose; the method may further include tilting the garden tool so that an edge of the garden tool pinches or bevels the hose; the handle of the garden tool may include at least one hook; the at least one hook may be an inwardly facing hook; the at least one hook may be a pair of hooks; and/or the method may further include disengaging the hose from the garden tool by rotating the garden tool.

Broadly defined, the present invention according to a fifth aspect includes a method of keeping a user's hands and clothes clean when using a hose, substantially as shown and described.

Broadly defined, the present invention according to a sixth aspect includes a hose support apparatus that includes a spine member defining an axis, a handle attached along the spine member, and first and second arcuate supports extending downwardly and inwardly from opposite sides of the spine member. The first arcuate support extends from the spine member at a first end thereof and the second arcuate support extends from the spine member at a second end thereof such that the arcuate supports are adapted to support a section of a hose co-axially aligned with the spine member.

In features of this aspect, each arcuate support may be tapered toward an exposed edge; each arcuate support may curve downwardly and inwardly from the spine member; and/or each arcuate support may define a substantially circular shape in the longitudinal direction.

In further features of this aspect, a longitudinal gap may exist between the first and second arcuate supports, the longitudinal gap sized to accommodate a hose diameter; at least one of the arcuate supports may include an aperture therein; at least one of the arcuate supports may include a rim to reduce splatter; at least one of the spine member, the handle and the first and second arcuate supports may be composed of a rigid material; at least one of the spine member, the handle and the first and second arcuate supports may be composed of a plastic material; and/or outer longitudinal edges of each arcuate support may include a ramp to facilitate hose engagement.

In still further features of this aspect, the handle may be integral with the spine member; the handle may include at least one hook to facilitate storage; and/or the at least one hook may be a pair of hooks.

Broadly defined, the present invention according to a seventh aspect includes a method of keeping a user's hands and clothes clean when using a hose. The method includes providing a garden tool having a handle attached along a spine member, defining an axis, with first and second arcuate supports extending downwardly and inwardly from the spine member at opposite sides thereof, the first arcuate support extending from the spine member at a first end of the spine member and the second arcuate support extending from the spine member at a second end thereof. The method further includes positioning the diameter of a hose at a gap between the first and second arcuate supports and arranging the garden tool to be co-axially aligned with the hose, thereby permitting a section of the hose to be supported by the first and second arcuate supports.

In feature of this aspect, the method may further include re-positioning the garden tool relative to the hose by moving the garden tool along the hose; and/or the method may further include tilting the garden tool so that an edge of the garden tool pinches or bevels the hose.

In further features of this aspect, the handle of the garden tool may include at least one hook; and/or the at least one hook may be an inwardly facing hook.

In still further features of this aspect, each arcuate support may include a rim to reduce splatter; and/or the method may further include disengaging the hose from the garden tool by rotating the garden tool.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a perspective view of a hose support apparatus in accordance with one or more embodiments of the present invention;

FIG. 2 is a right side view of the hose support apparatus of FIG. 1;

FIG. 3 is a left side view of the hose support apparatus of FIG. 1;

FIG. 4 is a top view of the hose support apparatus of FIG. 1;

FIG. 5 is a bottom view of the hose support apparatus of FIG. 1;

FIG. 6 is a front view of the hose support apparatus of FIG. 1;

FIG. 7 is a rear view of the hose support apparatus of FIG. 1;

FIG. 8 is a perspective view of the hose support apparatus of FIG. 1, shown with a section of hose positioned between arcuate hose supports; and

FIG. 9 is a perspective view of the hose support apparatus of FIG. 1, shown with a section of a hose co-axially aligned with the hose support apparatus.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of one or more preferred embodiment(s) is merely exemplary in nature and is in no way intended to limit the invention, its application, or uses.

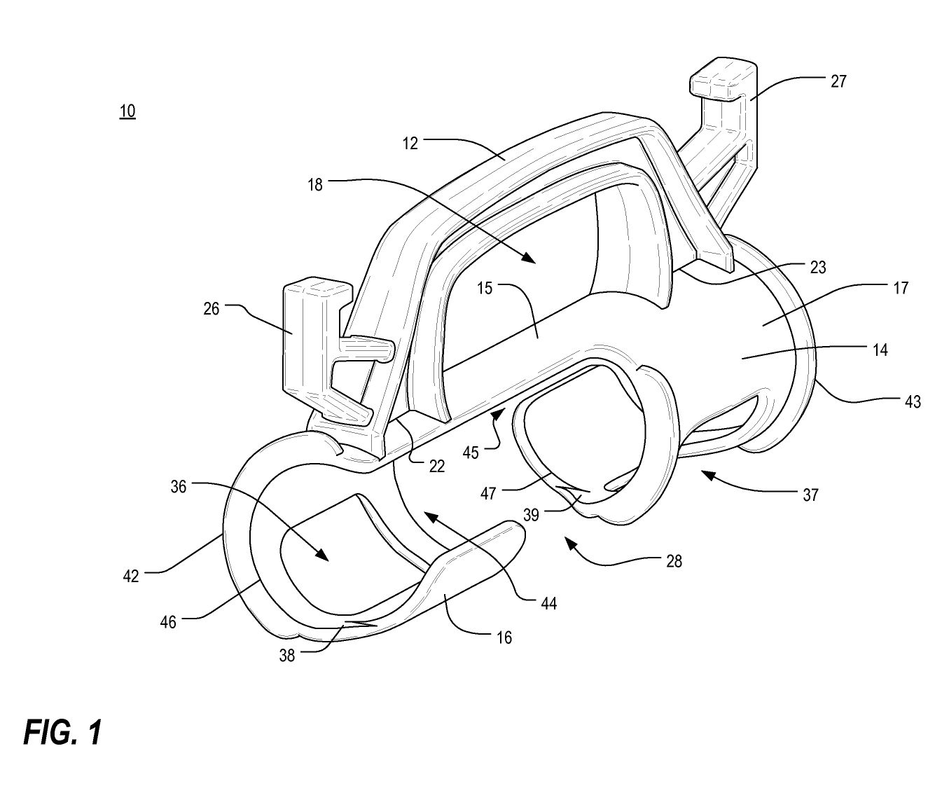

FIG. 1 is a perspective view of a hose support apparatus 10 in accordance with one or more embodiments of the present invention. As shown in FIG. 1, the hose support apparatus 10 includes a handle portion 12 and a hose engagement portion 14. The handle portion 12 is generally C-shaped and attaches along its base edges 22,23 to a spine member 15 of the hose engagement portion 14, thereby defining an opening 18 by which a user can grip the hose support apparatus 10. Positioned at opposite ends of the handle portion 12 are hooks 26,27 that permit the user to store the hose support apparatus 10 by suspending the hose support apparatus 10 on an exterior faucet or other location.

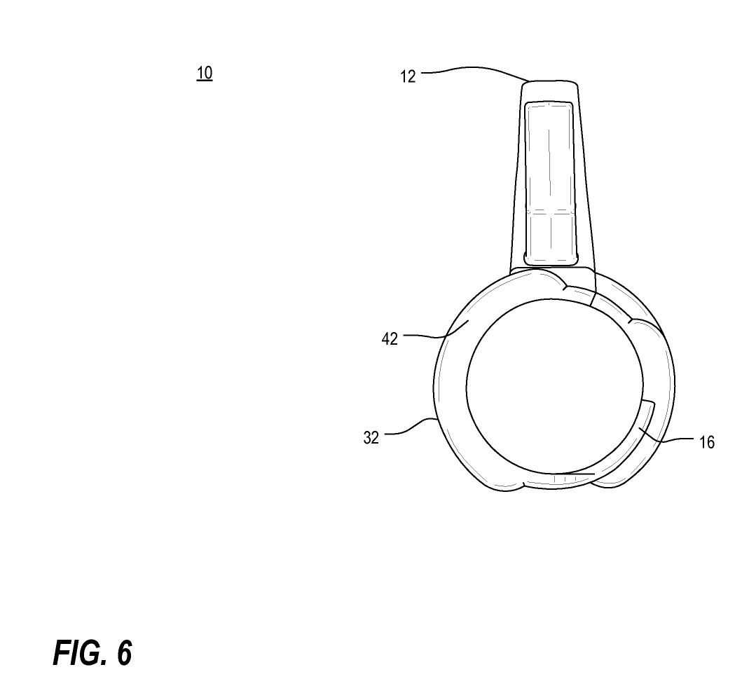

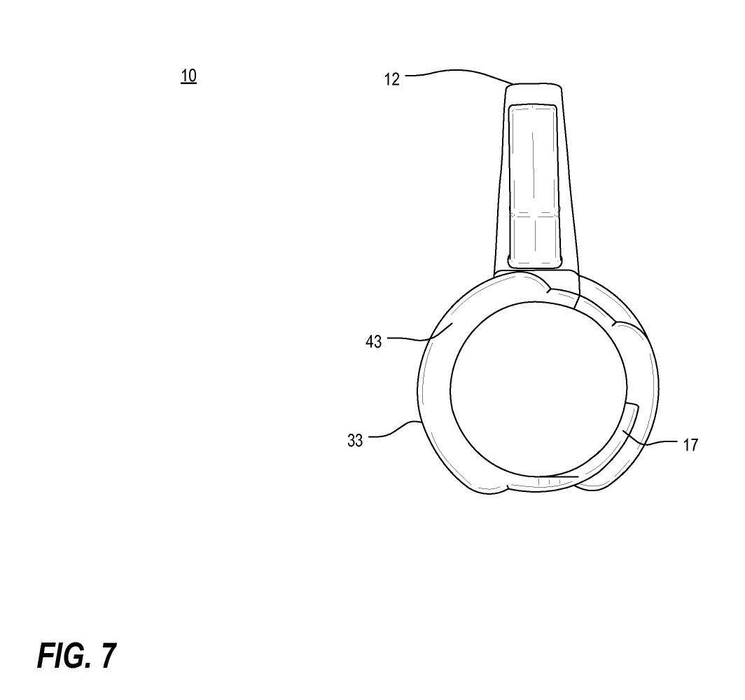

The hose engagement portion 14 includes opposing arcuate hose supports 16,17 generally at longitudinal ends thereof. The arcuate hose supports 16,17 are curved in such a way as to be capable of engaging and supporting a section of a garden hose. Each hose support 16,17 curves downwardly away from the spine member 15 with each forming a generally circular shape in the longitudinal direction (as perhaps best seen in FIGS. 6 and 7). Each arcuate hose support 16,17 includes a ramp 38,39 to help facilitate engagement of the hose support apparatus 10 with a hose. As further shown in FIG. 1, a gap 28 exists between the two arcuate hose supports 16,17. The gap 28 permits a user to insert a hose and rotate the hose support apparatus 10 into position so as to be capable of supporting the hose, as will be explained in greater detail below.

The hose support apparatus 10 is formed of a generally rigid material that is capable of withstanding the wear and tear of repeated outdoor use. While a range of different materials could be used to form the hose support apparatus 10, a plastic or polymeric material is used in contemplated embodiments. The plastic or polymeric material should be of a sufficient strength, thickness and durability as to be able to support and maintain control of a hose, even when the hose is in use with a stream of water running through the hose. In particular, it is contemplated that a 20% glass-filled polypropylene material may be used as the plastic or polymeric material. One such material is Multibase Multi-Pro® 2012 RC 20% Glass Filled Polypropylene, manufactured by Multibase Inc., based in Copland, Ohio. In another contemplated embodiment, the hose support apparatus 10 is formed of a lightweight, metallic material.

Though the length and dimensions of the hose support apparatus 10 may vary, one contemplated embodiment of the hose support apparatus 10 has a length sufficient to accommodate a handle portion 12 that can be comfortably gripped by a user. Furthermore, it is contemplated that each of the arcuate hose supports 16,17 has a diameter sufficient to engage a conventional garden hose. In one contemplated embodiment, the hose support apparatus 10 has a length of approximately 6½ inches, a height of approximately 4 inches and an internal diameter of approximately 2 inches.

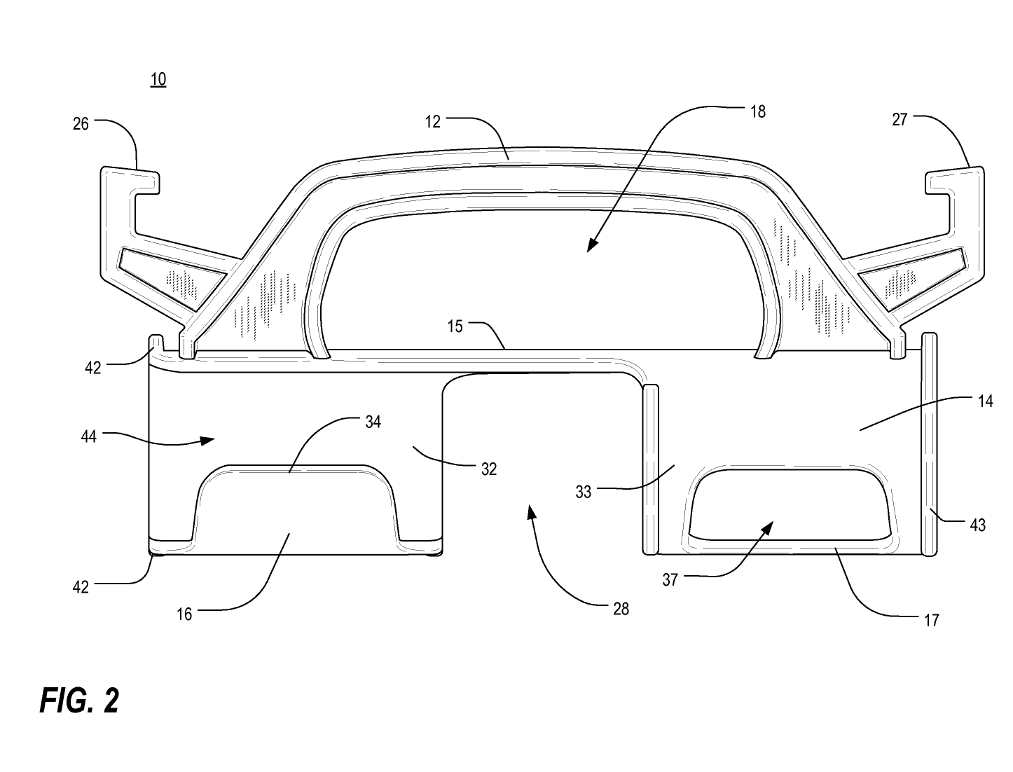

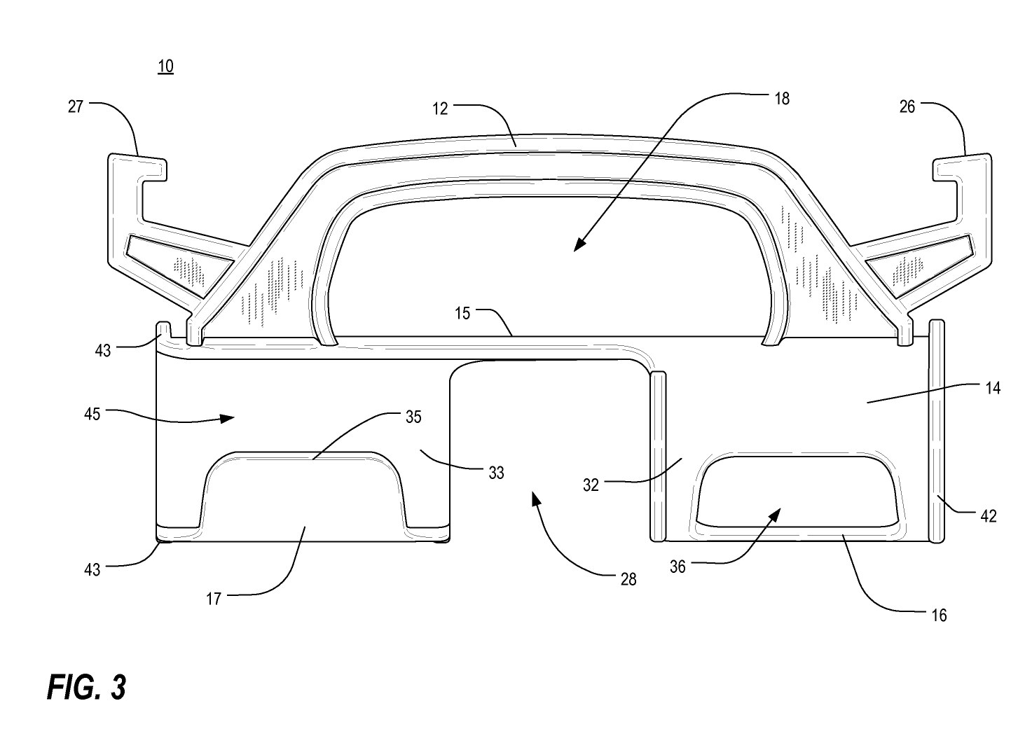

FIGS. 2 and 3 are right and left side views, respectively, of the hose support apparatus 10 of FIG. 1. As can be seen in FIGS. 2 and 3, the handle portion 12 attaches along the spine member 15. In a contemplated embodiment, the spine member 15 exhibits curvature that follows and complements the curvature of an engaged hose. The arcuate hose supports 16,17 extend downwardly from the spine member 15 away from the handle portion 12. As can be seen in FIGS. 2 and 3, arcuate hose support 16 has a curved sidewall 32 extending downwardly from the spine member 15 that terminates in an exposed edge 34 at the opposite side of the hose support apparatus 10. Likewise, arcuate hose support 17 has a curved sidewall 33 extending downwardly from the other side of the spine member 15 that terminates in an exposed edge 35 at the opposite side of the hose support apparatus 10 (i.e., on the same side as the sidewall 32 of arcuate hose support 16). Each curved sidewall 32,33 includes an aperture 36,37 to help reduce friction arising from an engaged hose being fed through the hose support apparatus 10.

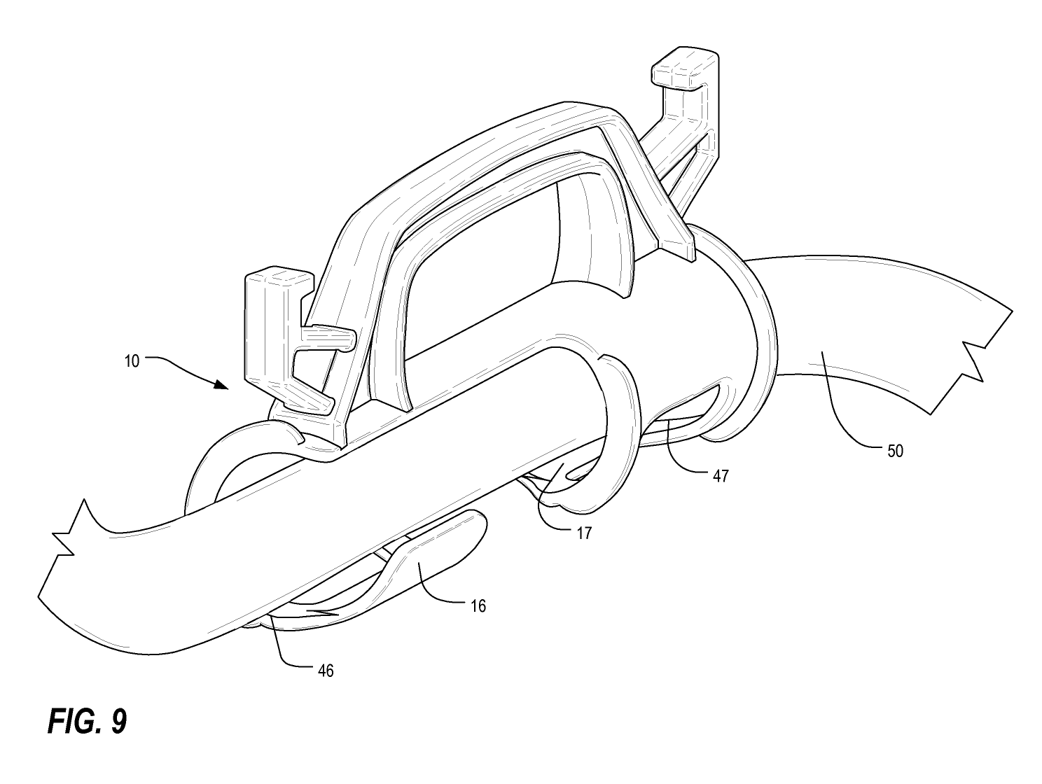

As can further be seen in FIGS. 1-3, the exposed edges 34,35 are tapered, which can help facilitate engagement of the hose support apparatus 10 with a hose. The arcuate hose supports 16,17 each include an inward edge 46,47, each with a ramp 38,39, as best seen in FIGS. 1 and 9, to further assist with hose engagement. Still further, outer edges of the curved sidewalls 32,33 each include a rim 42,43 that fans outwardly and is adapted to reduce splatter of water and mud when the hose support apparatus 10 is moved along the hose.

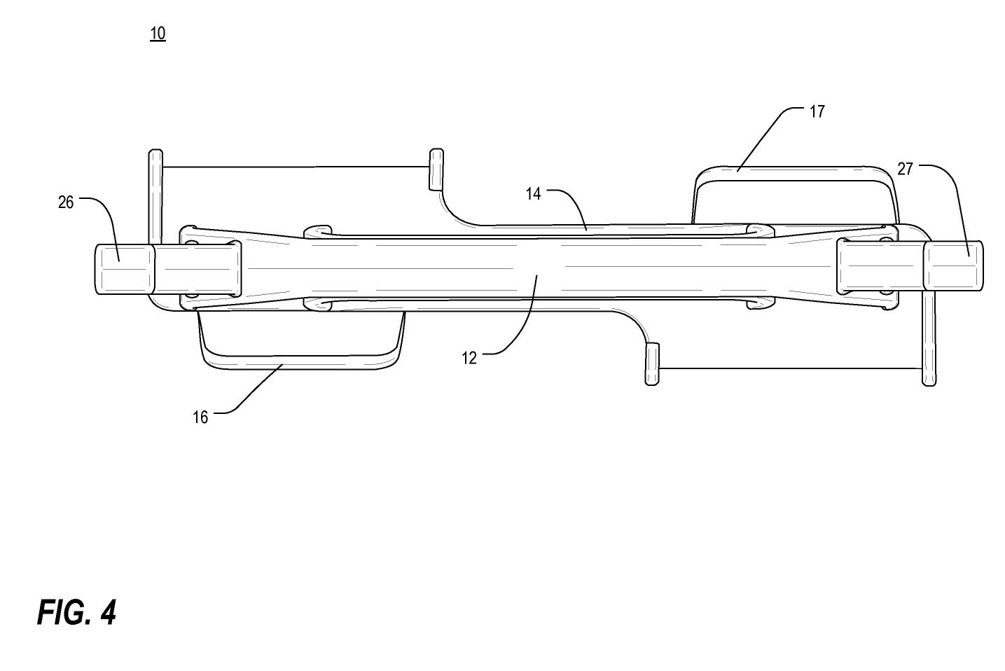

FIG. 4 is a top view of the hose support apparatus 10 of FIG. 1. As can be seen in FIG. 4, the handle portion 12 attaches to the spine member 15. Further, as can be seen in FIGS. 1-4, the handle portion 12 includes hooks 26,27 positioned at front and rear ends thereof. The hooks 26,27 face inwardly toward the center of the hose support apparatus 10 to facilitate storage by suspending the hose support apparatus 10 from an exterior faucet or hose retractor. In one contemplated embodiment, the hooks 26,27 are not inwardly facing. In another contemplated embodiment, the handle portion 12 has a single hook. In still another contemplated embodiment, the hooks 26,27 are positioned elsewhere on the hose support apparatus 10.

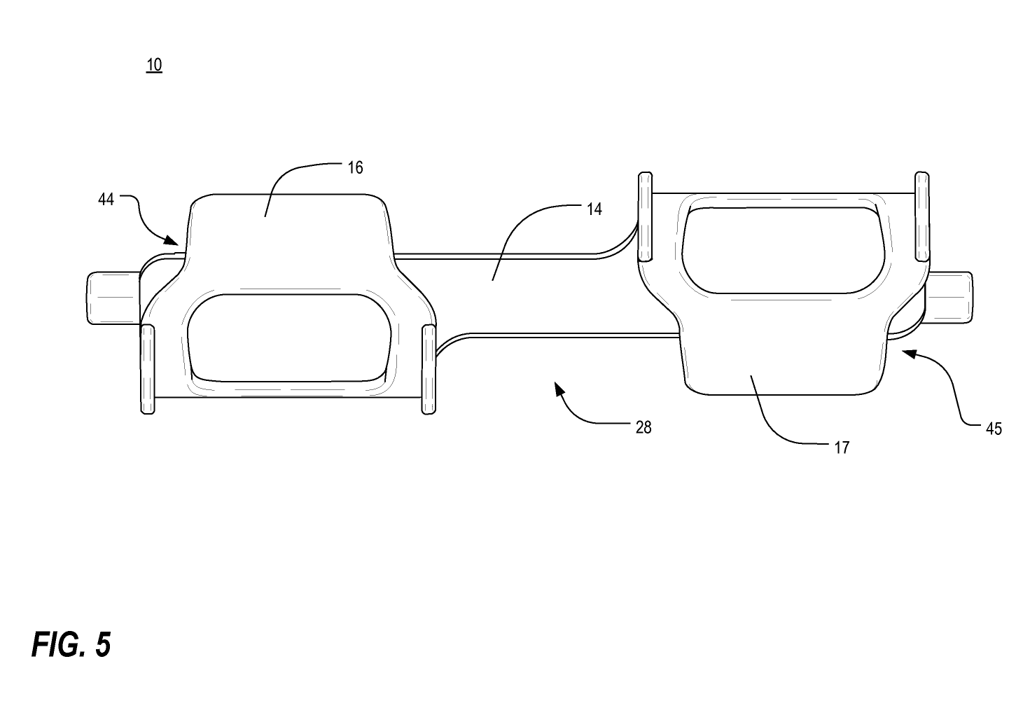

FIG. 5 is a bottom view of the hose support apparatus 10 of FIG. 1. As can be seen in FIG. 5, the gap 28 permits a user to insert a hose between the arcuate hose supports 16,17 so that the inserted section of hose is adjacent to the underside of the spine member 15. The hose support apparatus 10 is then rotated to be co-axially aligned with the hose. As perhaps best seen in FIGS. 1-3, gaps 44,45 between the arcuate hose supports 16,17 and the spine member 15 are sufficiently wide so as to accommodate the passing of the diameter of a conventional garden hose. In this manner, the user engages a hose by twisting the handle portion 12 of hose support apparatus 10 90 degrees to co-axially align with the hose. In at least one embodiment, it is contemplated that the user can maneuver the hose within the gaps 44,45 without twisting the hose support apparatus 10.

FIGS. 6 and 7 are front and rear views, respectively, of the hose support apparatus 10 of FIG. 1. As can be seen in FIGS. 6 and 7, the diameter of the hose support apparatus 10 is sufficiently large so as to accommodate the entire circumference of a hose. In this manner, accommodating the entire circumference allows the user to slide the hose support apparatus 10, via the handle portion 12, along the hose. Rims 42,43 on the outer edges of curved sidewalls 32,33 are positioned to protect a users hand from water and mud as the hose support apparatus 10 is moved along the hose or the hose is maneuvered through the hose support apparatus 10. As seen in FIGS. 6 and 7, the rims 42,43 do not extend all the way to the bottom of arcuate hose supports 16,17. In this manner, the rims 42,43 provide a desired path for debris, mud, or water to be removed from the hose.

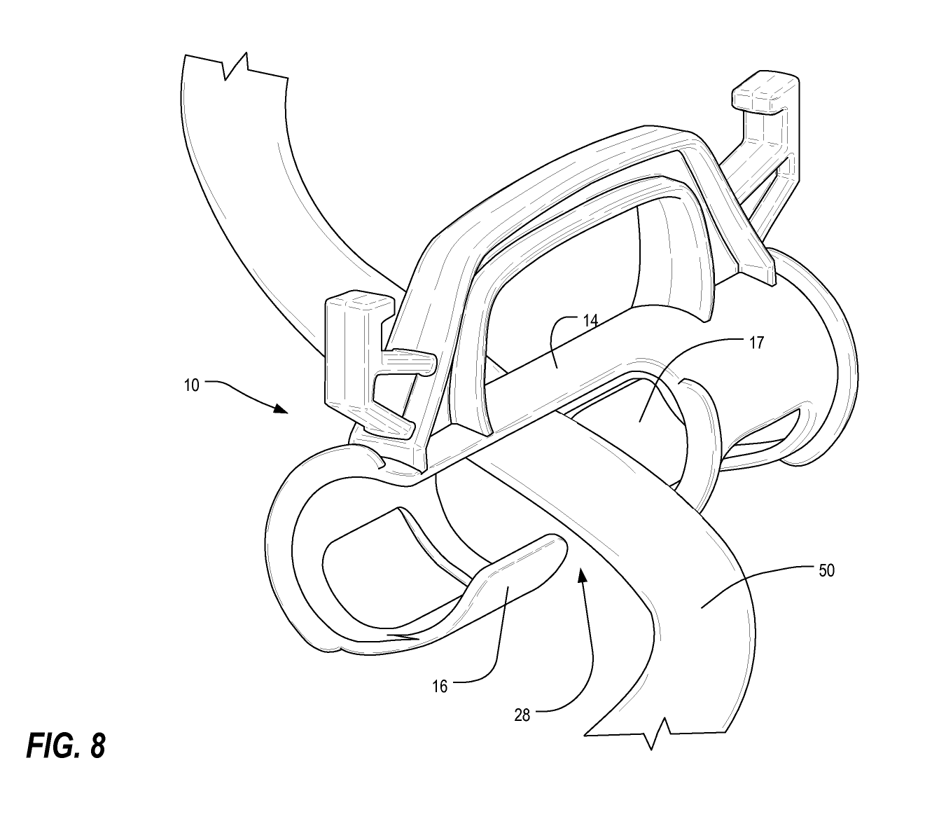

FIG. 8 is a perspective view of the hose support apparatus 10 of FIG. 1, shown with a section of a hose 50 inserted between the arcuate hose supports 16,17. FIG. 9 is a perspective view of the hose support apparatus 10 of FIG. 1, shown with a section of a hose 50 co-axially aligned with the hose support apparatus 10. In accordance with a method of using the hose support apparatus 10, a section of a hose 50 is inserted between the arcuate hose supports 16,17. Upon placement between the arcuate hose supports 16,17, the inserted section of the hose 50 is adjacent to the lower portion of the spine member 15. The hose support apparatus 10 can then be twisted, such as by a user holding the hose support apparatus 10 by the handle portion 12, about 90 degrees so as to co-axially align the hose support apparatus 10 with the hose 50. Once the hose support apparatus 10 is in co-axial alignment with the hose 50, the inward edges 46,47 of the arcuate hose supports 16,17 allow the user to slide the hose support apparatus 10 along the hose or to maneuver the hose 50 through the hose support apparatus 10. The user is thus able to move or slide the hose support apparatus 10 along the extent of the hose by holding the hose support apparatus 10 by the handle portion 12 and moving the hose support apparatus 10 to a desired location along the hose 50. In this manner, the user can effectively control, move, extend or retract the hose 50 without ever having to use his or her hands to touch the hose 50. The user can thereby protect his or her hands from the dirt, mud and grime that tends to accumulate on a hose during use. Furthermore, the user can reduce or stop the flow of water through the hose 50 by tilting the hose support apparatus 10 to cause one of the inward edges 46,47 to pinch or bevel the hose 50.

In one contemplated method of using the hose support apparatus 10, a user can co-axially align the hose support apparatus 10 with a section of the hose nearest to a conventional hose retractor. With one hand, the user can support the section of the hose, and with the other hand, the user can manipulate the hose retractor to reel in the hose for storage. As the hose retractor winds the hose onto the reel, the hose is moved through the hose support apparatus 10, and the user is able to guide the hose onto the hose retractor without ever having to use his or her hands to touch the hose. In like manner, the hose support apparatus 10 can be used to guide a hose as it is unwound from the hose retractor.

In other contemplated embodiments, the hose support apparatus 10 can be used to support different locations along the hose either by sliding the hose support apparatus along the hose or disengaging and reengaging the hose support apparatus 10 to a different location along the hose. In this manner, a user is able to reposition the hose, during use, without touching the hose. The need to reposition a hose that is in use can arise when the hose is being used to water various areas of a yard or a flower bed. By using the hose support apparatus 10 to reposition the hose, the hose can be relocated for further watering purposes without ever having to be touched by the user.

Though it is contemplated that the hose support apparatus 10 is used to engage an uncoiled hose, it should also be noted that the hose support apparatus 10 can be used to engage a coiled hose. Furthermore, the hose support apparatus 10 can be used to engage a hose, irrespective of whether the hose is elevated above the ground or positioned directly on the ground. Advantageously, the hose support apparatus 10 is adapted to engage the hose 50 at any desired location along the length of the hose. As a result, it is not necessary to thread or feed one of the ends of the hose 50 through the hose support apparatus 10. The hose support apparatus 10 is capable of engaging the hose 50 at either end or at any location in between the hose ends. The hose support apparatus 10 is thus configured to enable a user to control, move, extend or retract a hose without ever having to touch the hose.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A hose support apparatus comprising:
a spine member defining an axis;
a handle attached along the spine member; and
first and second arcuate supports extending downwardly and inwardly from opposite sides of the spine member;
wherein the first arcuate support extends from the spine member at a first end thereof and the second arcuate support extends from the spine member at a second end thereof such that the arcuate supports are adapted to support a section of a hose co-axially aligned with the spine member.

2. The hose support apparatus of claim 1, wherein each arcuate support is tapered toward an exposed edge.

3. The hose support apparatus of claim 1, wherein each arcuate support curves downwardly and inwardly from the spine member.

4. The hose support apparatus of claim 3, wherein each arcuate support defines a substantially circular shape in the longitudinal direction.

5. The hose support apparatus of claim 1, wherein a longitudinal gap exists between the first and second arcuate supports, the longitudinal gap sized to accommodate a hose diameter.

6. The hose support apparatus of claim 1, wherein at least one of the arcuate supports includes an aperture therein.

7. The hose support apparatus of claim 1, wherein at least one of the arcuate supports includes a rim to reduce splatter.

8. The hose support apparatus of claim 1, wherein at least one of the spine member, the handle and the first and second arcuate supports is composed of a rigid material.

9. The hose support apparatus of claim 1, wherein at least one of the spine member, the handle and the first and second arcuate supports is composed of a plastic material.

10. The hose support apparatus of claim 1, wherein outer longitudinal edges of each arcuate support include a ramp to facilitate hose engagement.

11. The hose support apparatus of claim 1, wherein the handle is integral with the spine member.

12. The hose support apparatus of claim 1, wherein the handle includes at least one hook to facilitate storage.

13. The hose support apparatus of claim 12, wherein the at least one hook is a pair of hooks.

14. A method of keeping a user's hands and clothes clean when using a hose, comprising:
providing a garden tool having a handle attached along a spine member, defining an axis, with first and second arcuate supports extending downwardly and inwardly from the spine member at opposite sides thereof, the first arcuate support extending from the spine member at a first end of the spine member and the second arcuate support extending from the spine member at a second end thereof;
positioning the diameter of a hose at a gap between the first and second arcuate supports; and
arranging the garden tool to be co-axially aligned with the hose, thereby permitting a section of the hose to be supported by the first and second arcuate supports.

15. The method of claim 14, further comprising re-positioning the garden tool relative to the hose by moving the garden tool along the hose.

16. The method of claim 14, further comprising tilting the garden tool so that an edge of the garden tool pinches or bevels the hose.

17. The method of claim 14, wherein the handle of the garden tool includes at least one hook.

18. The method of claim 17, wherein the at least one hook is an inwardly facing hook.

19. The method of claim 14, wherein each arcuate support includes a rim to reduce splatter.

20. The method of claim 14, further comprising disengaging the hose from the garden tool by rotating the garden tool.
